(19) United States
(12) Patent Application Publication
(10) Pub. No.: US 2018/0309525 A1
(43) Pub. Date: Oct. 25, 2018

(54) SYSTEM AND WIRELESS ACCESS DEVICE FOR IMPROVING RECEIVED SIGNAL QUALITY

(71) Applicant: WISTRON NEWEB CORPORATION, Hsinchu (TW)

(72) Inventor: CHEN-SHU PENG, HSINCHU (TW)

(21) Appl. No.: 15/726,484

(22) Filed: Oct. 6, 2017

(30) Foreign Application Priority Data
Apr. 24, 2017 (TW) 106113622

(51) Int. Cl. H04B 17/318; H04W 24/08; H04W 48/16; H04W 24/02

(52) U.S. Cl. CPC H04B 17/318; H04W 24/08; H04L 5/14; H04W 24/02; H04W 48/16

(57) ABSTRACT

A wireless access device includes multiple antennas, multiple paths connected to the multiple antennas, multiple filter circuits configured on the multiple paths, and a processor for controlling the multiple filter circuits. The processor calculates the received signal strength indicators (RSSI) of the multiple antennas, determines an operating band, and selects an antenna with the strongest RSSI accordingly. The processor selects a path according to the antenna and the operating band, and controls at least one of the multiple filter circuits on the paths to improve the quality of the signal received by the wireless access device.

### BACKGROUND OF THE INVENTION

### 1. Field of the Invention

The present disclosure relates to signal quality improvement; more particularly, to a system and a wireless access device for improving the signal quality of received signals.

### 2. Description of Related Art

Long term evolution (LTE) has been widely adopted around the globe. Different bands are used in different continents such as Europe, the Americas and Asia. Among these bands, some of the bands are too close, which results in insufficient isolation in between, for example, as shown in FIG. 1, the gap between band B7 (B7UL FDD [symbol] B7DL FDD) and band B38 (B38 TDD). In order to deal with signal interference (inter-band interference) among these bands due to insufficient isolation, the use of cavity filters or waveguide filters is usually a solution for manufacturers. However, such filters are usually bulky and costly.

### SUMMARY OF THE INVENTION

A system and method for cancelling radio frequency (RF) interferences are provided in the present disclosure to solve the problems as addressed above, while the signal interferences of adjacent frequency bands are cancelled in so that the received signal quality is improved as well.

The wireless access device of the present disclosure includes: a plurality of antennas; a plurality of paths connected with the plurality of antennas; a plurality of filter circuits disposed on the plurality of paths; and a processor configured to control the plurality of filter circuits. The processor calculates received signal strength indicators (RSSI) of the plurality of antennas, determines an operating band and selects an antenna with the strongest RSSI according to the RSSIs of the plurality of antennas, selects a path according to the plurality of antennas and the operating band, and controls at least one of the plurality of filter circuits on the selected path to improve a quality of a signal received by the wireless access device.

The system of the present disclosure for improving signal quality of a received signal includes a first wireless access device including: a plurality of first antennas, a plurality of first paths connected with the plurality of first antennas, a plurality of first filter circuits disposed on the plurality of first paths, and a first processor configured to control the plurality of first filter circuits; and a second wireless access device connecting with the first wireless access device through a connecting port. The first processor calculates received signal strength indicators (RSSI) of the plurality of first antennas, determines a first operating band and selects an antenna with the strongest RSSI according to the RSSIs of the plurality of first antennas, selects a first path according to the plurality of first antennas and the first operating band, and controls at least one of the plurality of first filter circuits on the first paths to improve a quality of a received signal.

In order to further the understanding of the present disclosure, the following embodiments are provided along with illustrations to facilitate the disclosure of the present disclosure.

### BRIEF DESCRIPTION OF THE DRAWINGS

FIG. 1 is a schematic view illustrating an inter-band interference of the Long Term Evaluation (LTE) technology;

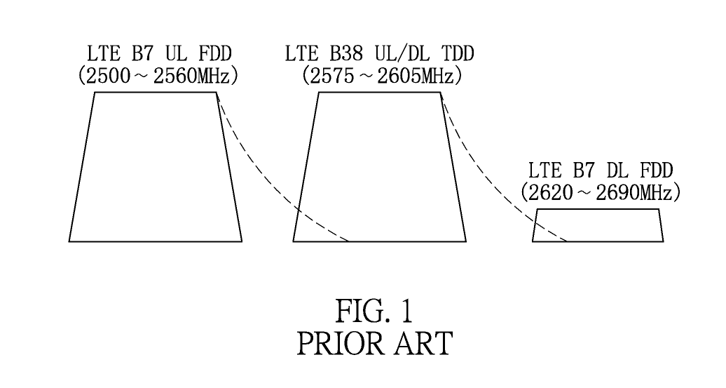

FIG. 2 is a schematic view illustrating the system for improving the signal quality of a received signal of the present disclosure;

FIG. 3 is a schematic view illustrating the system functional block of the wireless access device according to an embodiment of the present disclosure;

FIG. 4 is a schematic view illustrating the system functional block of the wireless access device according to another embodiment of the present disclosure;

FIG. 5 is a schematic view illustrating the filter circuit according to an embodiment of the present disclosure; and

FIG. 6 is a schematic view illustrating the interference cancellation of bands of the present disclosure.

### DETAILED DESCRIPTION OF THE PREFERRED EMBODIMENTS

The aforementioned illustrations and following detailed description are exemplary for the purpose of further explaining the scope of the present disclosure. Other objectives and advantages related to the present disclosure will be illustrated in the following description and appended drawings.

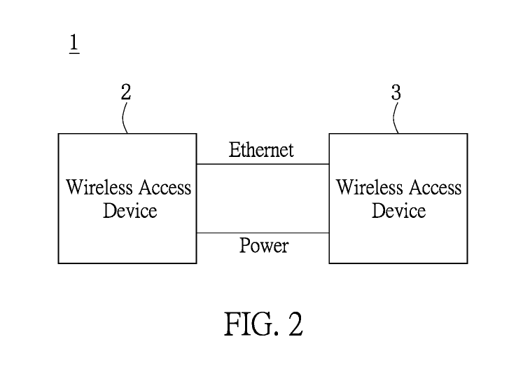

The system 1 for improving received signal quality of the present disclosure is applied for long term evolution (LTE) technology. FIG. 2 is a schematic view illustrating the system for improving the signal quality of a received signal of the present disclosure. The system 1 for improving signal quality of the present disclosure includes wireless access devices 2 and 3. The wireless access devices 2 and 3 are connected with and exchanged information each other via a connection port, for example, exchanging the bands (frequency bands), the channels or the configuration information operated by the wireless access devices 2 and 3, so as allowing the wireless access devices 2 and 3 to be capable of being aware of whether the bands in operation are adjacent. Exemplarily, the connection port is an Ethernet connection port. The wireless access devices 2 and 3 may be small cells or mobile hotspots. The wireless access devices 2 and 3 may also be base stations, small cell or hotspots capable of connecting to the Internet. Taking small cells as an example, the supported bands are, at least, band 3, band 7 and band 38. Taking mobile hotspots as an example, the supported bands are, at least, band 1, band 3, band 7 and band 20. One with ordinary skill in the art may, based on the system, design the availability of the supporting bands to small cells and mobile hotspots, so that the present disclosure is not limited by the above-mentioned bands. It should be noted that the system 1 of the present disclosure for improving signal quality can include one wireless access device, or more than two wireless access devices. The number of wireless access devices is not limited in the present disclosure.

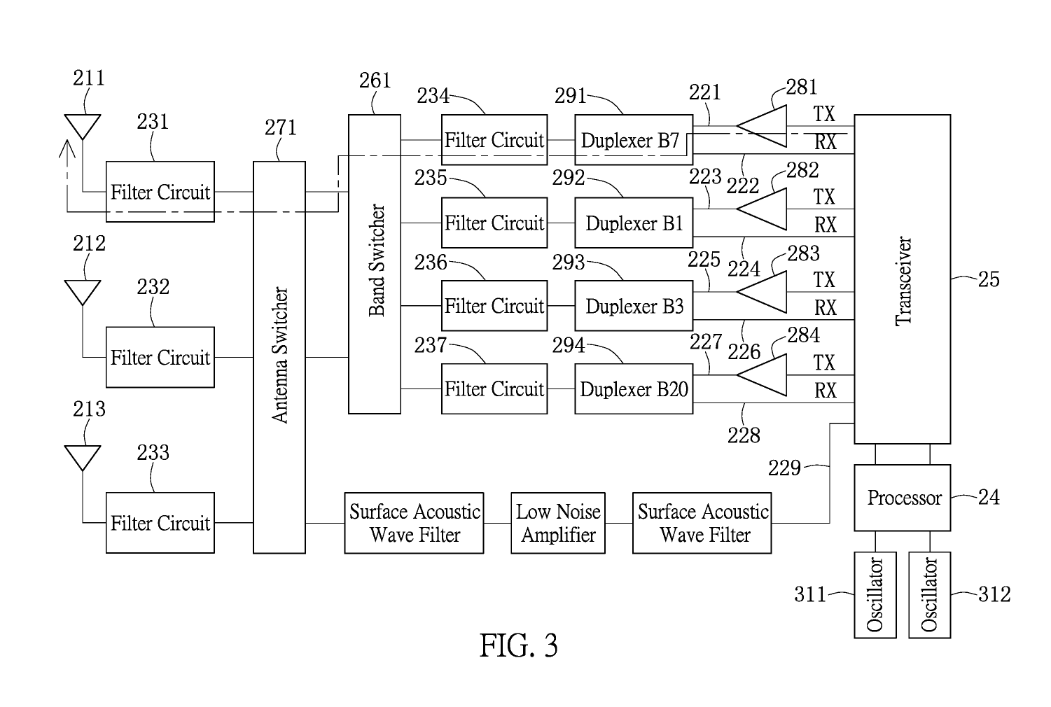

FIG. 3 is a schematic view illustrating the system functional block of the wireless access device according to an embodiment of the present disclosure. A mobile hotspot is used as an example in FIG. 3, the mobile hotspot including antennas 211-213, paths 221-229, filter circuits 231-237, a processor 24, a transceiver 25, a band switcher 261, an antenna switcher 271, power amplifiers 281-283, duplexers 291-294 and oscillators 311, 312.

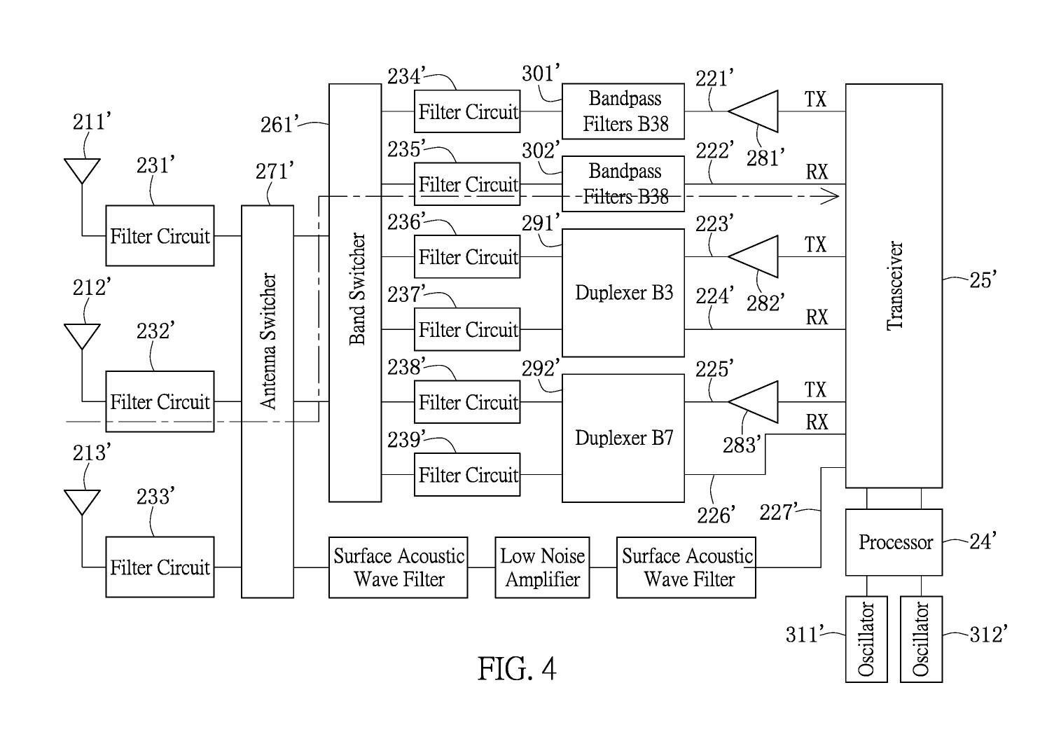

FIG. 4 is a schematic view illustrating the system functional block of the wireless access device according to another embodiment of the present disclosure. A small cell is used as an example in FIG. 4, the small cell including antennas 211′-213′, paths 221′-227′, filter circuits 231′-239′, a processor 24′, a transceiver 25′, a band switcher 261′, an antenna switcher 271′, power amplifiers 281′-283′, duplexers 291′-292′, bandpass filters 301′-302′ and oscillators 311′, 312′.

According to LTE standards, the bands operated for small cells and mobile hotspots can be frequency division duplexing (FDD) and time division duplexing (TDD). The properties of the power amplifier, duplexer and bandpass filter for different operated bands are different. Furthermore, the oscillators 311′, 312′ of the small cell can include a voltage control oscillator.

Taking FIG. 3 as an example, the paths 221-229 are respectively from the transceiver 25 to the antennas 211-213, and the transceiver 25 can, by switching of the antenna switcher 271, transmit and receive radio signals from different antennas 211-213. The filter circuits 231-237, the band switcher 261, the antenna switcher 271, the power amplifiers 281-284 and the duplexers 291-294 are all on each of the paths 221-228. The processor 24 is coupled with the filter circuits 231-237, the transceiver 25, the band switcher 261 and the antenna switcher 271, so as allowing the processor 24 control the filter circuits 231-233 to adjust the RSSI of antennas 211-213 for increasing the signal quality (including cancelling the interference of the radio signal at adjacent frequency bands), and to control the filter circuits 234-237 to adjust the impedance matching of the paths 221-228. The processor 24 receives the signals on the paths 221-229 provided by the transceiver 25. The processor controls the band switcher 261 to select an operating band among multiple bands. The processor 24 also, according to the strongest RSSI, controls the antenna switcher 271 to select an antenna among the antennas 211-213 to transmit the wireless signal.

It should be noted that, the mobile hotspots and the small cells as illustrated in FIGS. 3 and 4 are just examples. Persons of ordinary skill in the art may determine, according to the system demand (e.g., band, FDD or TDD), the number of antennas, paths, filter circuits, frequency switches, antenna switches, power amplifiers, duplexers, bandpass filters and oscillators of the mobile hotspot and the small cell as shown in FIGS. 3 and 4. Thus, the example as illustrated in FIGS. 3 and 4 should not limit the scope of the present disclosure.

In one embodiment, on each of the paths of the mobile hotspot and the small cell, the filter circuit can be disposed between the antenna and the antenna switcher. Exemplarily, more than one filter circuit can be disposed on each path of the mobile hotspot and the small cell. For example, in the mobile hotspot, the filter circuit can further be disposed between the band switcher and the duplexer and between the band switcher and the bandpass filter; while in the small cell, the filter circuit can be disposed between the band switcher and the bandpass filter and between the band switcher and the duplexer. What should be further explained is, since the filter circuit disposed between the band switcher and the duplexer or the filter circuit disposed between the frequency switcher and the bandpass filter is additionally added, and in consideration of decreasing the number of filter circuits and cancelling inter-band interference, the filter circuit can be disposed between the antenna and the antenna switcher, and can additionally be disposed on the paths of the band B7 and B38 (Note: B7 and B38 are adjacent bands) to cancel the interference of the radio signal at adjacent bands, thereby obtaining the best signal quality of the received signal.

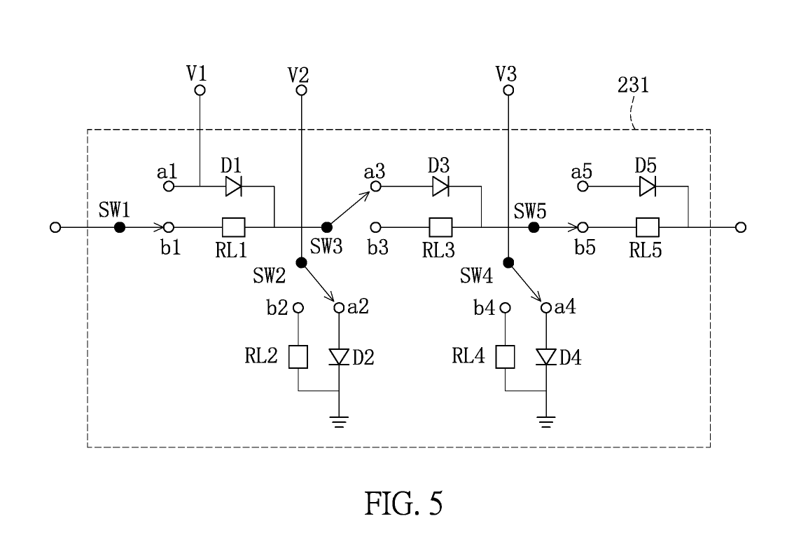

FIG. 5 is a schematic view illustrating the filter circuit according to an embodiment of the present disclosure. Taking the filter circuit 231 as an example, the filter circuit 231 includes multiple resistors RL1-RL6, multiple voltage-controlled positive intrinsic negative (PIN) diodes and multiple switches SW1-SW5. The processor 24 controls the input voltage terminals V1, V2 and V3 of the filter circuit 231 and the switches SW1-SW5 to implement filtering, so as allowing an order of the filter circuit 231 to be greater than 3. As shown in FIG. 5, the processor controls the switch SW1, the switch SW12, the switch SW3, the switch SW4 and the switch SW5, of the filter circuit 231 to connect respectively to b1, a2, a3, a4 and b5. Exemplarily, the processor 24 controls the input voltage terminal V1 of filter circuit 231 to be 0V, the input voltage terminal V2 of filter circuit 231 to be 2.5V, the input voltage terminal V3 of filter circuit 231 to be 0.5V, the resistor RL1 to be 0Ω and the resistor RL2 to be 0Ω, so as allowing the filter circuit 231 to be an order 3 filter (relevant details may be referred to in U.S. Pat. No. 8,045,928). It should be noted that, persons of ordinary skill in the art can, by different demands for the order, expand the filter circuit to obtain the filter circuit with corresponding order, and thus the order of the filter circuit should not limit the scope of the present disclosure. The processor 24 can therefore adjust the RSSI of the antenna 211 to increase the signal quality of the received signal. Moreover, the filter circuit of the present disclosure can further be an active resistor-capacitor (RC) multi-order filter, an active inductor-capacitor (LC) multi-order filter and etc., while one with ordinary skill in the art can design the filter circuit according to different demands. Thus, there should be no limitations imposed on the present disclosure in this respect.

References are collectively made to FIGS. 2, 3 and 4, in which the wireless access device 2 is exemplified as a small cell and the wireless access device 3 is exemplified as a mobile hotspot. When the mobile hotspot transmits the radio signal through band B7 and the small cell receives the radio signal through band B38, or the mobile hotspot transmits the radio signal through band B38 and the small cell receives the radio signal through band B7, due to the fact that band 7 and band 38 are too close, the radio signals on the two bands would interfere with each other, which effects the signal quality. Therefore, the system 1 for increasing signal quality of the present disclosure performs interference cancellation to cancel the inter-band radio signal interference.

In one embodiment, before the mobile hotspot transmits the radio signal through band B7 and the small cell receives the radio signal through band B38, the processor 24′ of the small cell and the processor 24 of the mobile hotspot would respectively calculate the RSSIs of the antennas 211′-213′ of the small cell and the antennas 211-213 of the mobile hotspot. The processor 24′ of the small cell would, according to all the RSSIs of the antennas 211′-213′, select the optimal antenna 212′ and the operating band, e.g., band B38. The processor 24 of the mobile hotspot would, according to all the RSSIs of the antennas 211-213, select the optimal antenna 211 and the operating band, e.g., band B7. It should be stressed that, the basis of selection of the operating band as mentioned above is that, when more than two bands are supported by the wireless access device 2, the processor of the wireless access device 2 selects the optimal antenna and the operating band according to each supported frequency accompanied with the RSSI obtained by different antennas. However, when only one band is supported by the wireless access device 2, the processor of the wireless access device 2 needs only to determine the optimal antenna according to the RSSIs of different antennas, and the processor determines the supported band to be the operating band. The processor 24′ of the small cell and the processor 24 of mobile hotspot respectively calculate the period of the RSSIs of the antennas 211′-213′ and 211-213 to be 10 microseconds/per time. However, people with ordinary skill in the art can adjust the period according to practical demands, and the present disclosure should not be limited to the period as addressed above. In the embodiment, the mobile hotspot transmitting the radio signal through band B7 and the small cell receiving the radio signal through band B38, the processor 24′ of the small cell may select, between the antenna 212′ and the transceiver 25′, the receiving path 222′ (the dotted lines as shown in FIG. 4) of the radio signal through band B38. The processor 24 of the mobile hotspot may select, between the antenna 211 and the transceiver 25, the transmitting path 221 (the dotted lines as shown in FIG. 3) of the radio signal of band B7. At this time, the small cell and the mobile hotspot are informed via Ethernet that the bands in use are adjacent.

When the mobile hotspot transmits the radio signal of band B7 and the small cell receives the radio signal of band B38, the processor 24′ of the small cell would, on the path of the radio signal of band B38, control the filter circuit 232′ to increase the transmission efficiency of the antenna 212′ and to cancel inter-band (band B7) radio signal interference, further improving the signal quality of the received signal. The processor 24 of the mobile hotspot would, on the path of the radio signal of band B7, control the filter circuit 231 to adjust the RSSI to increase the transmission efficiency of antenna 211.

When the band that the mobile hotspot transmits and receives the radio signal is not adjacent with the band that the small cell transmits and receives the radio signal, the processor 24′ of the small cell and the processor 24 of the mobile hotspot would, respectively, control the filter circuits 231′-231 and 231-233 on the path of the transmitting and receiving band to adjust the RSSI to increase the transmission efficiency of antennas 211′-213′ and 211-213, further increasing the signal quality of the received signal.

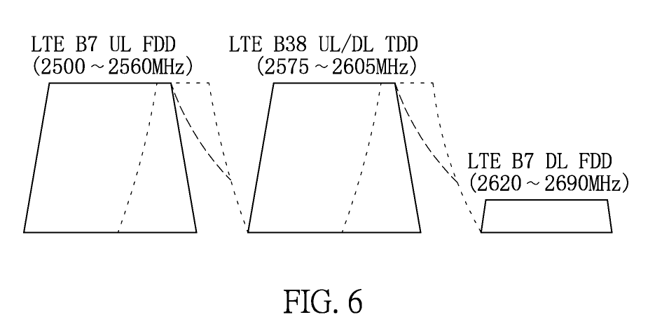

FIG. 6 is a schematic view illustrating the interference cancellation of bands of the present disclosure. The system 1 according to the present disclosure and the filter circuit provided in the filter circuit can not only cancel the inter-band radio signal interference, but can also, as shown in FIG. 6, improve the RSSI of the antennas to increase the transmission efficiency of the antennas.

In sum, the system and the wireless access device for cancelling radio frequency interferences are provided in the present disclosure to solve the problems as addressed above, while the signal interferences of adjacent bands are cancelled so that the received signal quality is improved as well. Moreover, the system and the wireless access device can be adopted in other wireless communication systems.

The description illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A wireless access device, comprising:
a plurality of antennas;
a plurality of paths connected with the plurality of antennas;
a plurality of filter circuits disposed on the plurality of paths; and
a processor configured to control the plurality of filter circuits;
wherein the processor calculates received signal strength indicators (RSSI) of the plurality of antennas, determines an operating band, selects an antenna with the strongest RSSI according to the RSSIs of the plurality of antennas, selects a path according to the plurality of antennas and the operating band, and controls at least one of the plurality of filter circuits on the selected path to improve a quality of a signal received by the wireless access device.

2. The wireless access device according to claim 1, wherein the processor selects the operating band with the strongest RSSI according to the RSSIs of the plurality of antennas.

3. The wireless access device according to claim 1, further comprising:
a transceiver connected with the processor;
a band switcher; and
a duplexer coupled with the transceiver and the band switcher, the duplexer being disposed between the transceiver and the band switcher;
wherein the processer controls the band switcher to select the operating band, and at least one of the plurality of filter circuits is disposed between the duplexer and the band switcher.

4. The wireless access device according to claim 1, further comprising:
a transceiver connected with the processor;
a band switcher; and
a bandpass filter coupled with the transceiver and the band switcher, the bandpass filter being disposed between the transceiver and the band switcher;
wherein the processer controls the band switcher to select the operating band, and at least one of the plurality of filter circuits is disposed between the bandpass filter and the band switcher.

5. The wireless access device according to claim 1, further comprising:
an antenna switcher coupled with the processer and the plurality of antennas;
wherein the processor controls the antenna switcher to select the antenna among the plurality of antennas, and the plurality of filter circuits are disposed between the antenna switcher and the plurality of antennas.

6. The wireless access device according to claim 1, wherein the processor controls an input voltage of the at least one of the plurality of filter circuits on the selected path to adjust an order of the at least one of the plurality of filter circuits, and the order is greater than 3.

7. The wireless access device according to claim 1, wherein the wireless access device is a small cell or a mobile hotspot.

8. A system for improving signal quality of a received signal, comprising:
a first wireless access device including:
a plurality of first antennas;
a plurality of first paths connected with the plurality of first antennas;
a plurality of first filter circuits disposed on the plurality of first paths; and
a first processor configured to control the plurality of first filter circuits; and
a second wireless access device connecting with the first wireless access device through a connecting port;
wherein the first processor calculates received signal strength indicators (RSSI) of the plurality of first antennas, determines a first operating band, selects an antenna with the strongest RSSI according to the RSSIs of the plurality of first antennas, selects a first path according to the plurality of first antennas and the first operating band, and controls at least one of the plurality of first filter circuits on the first path to improve a quality of a received signal.

9. The system according to claim 8, wherein the first processor selects the first operating band with the strongest RSSI according to the RSSIs of the plurality of first antennas.

10. The system according to claim 8, wherein the first wireless access device further includes:
a first transceiver coupled with the first processor;
a first band switcher;
a first duplexer coupled with the first transceiver and the first band switcher, the first duplexer being disposed between the first transceiver and the first band switcher; and
a first bandpass filter coupled with the first transceiver and the first band switcher, the first bandpass filter being disposed between the first transceiver and the first band switcher;
wherein the first processer controls the first band switcher to select the first operating band, at least one of the plurality of first filter circuits is disposed between the first duplexer and the first band switcher or at least one of the plurality of first filter circuits is disposed between the first bandpass filter and the first band switcher.

11. The system according to claim 8, wherein the first wireless access device further includes:
a first antenna switcher coupled with the first processer and the plurality of first antennas;
wherein the first processor controls the first antenna switcher to select the antenna among the plurality of first antennas, and the plurality of first filter circuits are disposed between the first antenna switcher and the plurality of first antennas.

12. The system according to claim 8, wherein the connecting port is an Ethernet port.

13. The system according to claim 8, wherein the first wireless access device is configured to receive a first wireless signal through the first operating band, the second wireless access device is configured to transmit a second wireless signal through a second operating band, and the first operating band is adjacent to the second operating band.

14. The system according to claim 8, wherein the first processor controls an input voltage of the at least one of the plurality of first filter circuits on the first path to adjust an order of the at least one of the plurality of first filter circuits, and the order is greater than 3.

15. The system according to claim 13, wherein the second wireless access device includes:
a plurality of second antennas;
a plurality of second paths connected with the plurality of second antennas;
a plurality of second filter circuits disposed on the plurality of second paths; and
a second processor configured to control the plurality of second filter circuits;
wherein the second processor calculates received signal strength indicators (RSSI) of the plurality of second antennas, determines a second operating band, selects an antenna with the strongest RSSI according to the RSSIs of the plurality of second antennas, selects a second path according to the plurality of second antennas and the second operating band, and controls at least one of the plurality of second filter circuits on the second path to improve a quality of a received signal.

16. The system according to claim 15, wherein the second wireless access device further includes:
a second transceiver coupled with the second processor;
a second band switcher;
a second duplexer coupled with the second transceiver and the second band switcher, the second duplexer being disposed between the second transceiver and the second band switcher; and
a second bandpass filter coupled with the second transceiver and the second band switcher, the second bandpass filter being disposed between the second transceiver and the second band switcher;
wherein the second processer controls the second band switcher to select the second operating band;
wherein at least one of the plurality of second filter circuits is disposed between the second duplexer and the second band switcher or at least one of the plurality of second filter circuits is disposed between the second bandpass filter and the second band switcher.

17. The system according to claim 15, wherein the second wireless access device further includes:
a second antenna switcher coupled with the second processer and the plurality of second antennas;
wherein the second processor controls the second antenna switcher to select the second antenna among the plurality of second antennas, and the plurality of second filter circuits are disposed between the second antenna switcher and the plurality of second antennas.

18. The system according to claim 15, wherein the second processor controls an input voltage of the at least one of the plurality of second filter circuits on the second paths to adjust an order of the at least one of the plurality of second filter circuits, and the order is greater than 3.
